(19) United States
(12) Patent Application Publication
(10) Pub. No.: US 2007/0225621 A1
(43) Pub. Date: Sep. 27, 2007

(54) Message apparatus

(76) Inventors: Courtney Sebastian, Centreville, VA (US); Mark Lewis Sebastian, Centreville, VA (US)

Correspondence Address: Courtney Sebastian, 5684 General Johnston Place, Centreville, VA, 20120, US

(21) Appl. No.: 11/723,556

(22) Filed: Mar. 21, 2007

Related U.S. Application Data
(60) Provisional application No. 60/783,845, filed on Mar. 21, 2006.

(51) Int. Cl. A61H 7/00

(52) U.S. Cl. 601/6; 601/7; 601/122

(57) ABSTRACT

The Invention relates to a massaging and skin suction apparatus for smoothing the skins surface caused by fat irregularities associated with cellulite fat tissues; comprising of two, stationary and distinct positioning rollers which provide massaging, while suction from a 12 Amp vacuum cleaner pulls skin between rollers; providing a push, pull and squeeze technique. This technique is allows the use of one person to perform the function of massaging.

### CROSS REFERENCE TO RELATED APPLICATIONS

This application claims priority from Provisional Patent Application No. 60/783,845.

### TECHNICAL FIELD

The present invention relates to a simple new type of skin and muscle stimulation apparatus, the Massage apparatus, that can be used with ease by human beings, using one hand to operate, in the privacy of their own homes with any standard 12 amp vacuum connected to any standard vacuum hose, and more particularly to the massage apparatus, the Massage apparatus, in which an action of pushing, pulling and sucking of the skin tissue is performed on the subject, by the subject, for smoothing the skin and fat irregularities and to improve the appearance of the skin contour irregularities associated with cellulite and any skin irregularities associated with any liposuction procedure including suction assisted lipectomy, ultrasonic assisted lipectomy, and direct lipectomy; improving the contour irregularities associated with any liposuction procedure.

### BACKGROUND OF THE INVENTION

The invention concerns a massage and skin suction apparatus comprising a housing whereof part of the wall is shaped to be used as a prehensile element and whereof the other part comprises of a pair of parallel stimulating rollers spaced uniquely from each other, each roller being rotatably mounted stationary about its axis of revolution, said rollers being associated with means for driving them in rotation when they are in contact with the skin tissue, to exert thereon two opposed forces for pulling a portion of said tissue in the space separating them, in order to pinch it and a chamber connected to a suction source and provided with a suction opening. Said suction opening and said pair of massaging rollers being arranged on said housing for placing them simultaneously in contact with a portion of the skin tissue. Said suction source is intended to be any standard 12 amp vacuum cleaner connected to any standard vacuum hose. This invention relates to a method of operating a self operated massage device, connected to said suction opening, for smoothing the skin and fat irregularities associated with cellulite and any liposuction procedure including suction assisted lipectomy, ultrasonic assisted lipectomy, and direct lipectomy; improving the contour irregularities associated with cellulite and any liposuction procedure in the privacy of an individual's home.

Successful use has been made of weekly treatments to reduce the unsightly and uncomfortable effects of cellulite, as a question of massage of the type called “palpate-roll”, which consists in forming a skin fold by compressive pinching and in displacing it by causing this fold to “roll” in proportion with the displacement. The other treatment is hypovascularization associated with tissue and lymphatic suction drainage using local suction techniques effectuated on the parts to be treated.

Cellulite is manifested by a hypertrophy of the fatty lobes of the hypodermas leading to a retraction of the vertical walls of the connecting tissue, which pulls the dermis and the epidermis on the hypertrophied fatty lobes. It is this which gives the skin affected with cellulite this aspect resembling an orange peel. The “palpate-roll” type of massage has a defibrating effect: the pressure followed by the pulling applied to the skin tissue has as its effect to stimulate the elastin fibers. Stimulation of the fibers, associated with decongestion of the tissues, has for its effect to return to the skin its good tone. The defibrating improves the trophicity of the tissues and acts on their restructuring. Progressive placing under tension of the tissues at the level of the rolled skin fold accelerates the phenomenon of tissue softening. The releasing of the fibers of the vertical walls limits the stresses responsible for “orange peel”.

Hypervascularization provokes a blood mobilization in the capillaries improving the trophicity and the cellular nutrition in depth and at a distance. The suction drainage improves the trophicity and simultaneously softens the tissues leading to a better sliding of the skin tissue layers. It permits liquids (interstitial liquids, water, blood, lymph) to better transport the nutrient supply and to better evacuate toxins. The tissue spaces are better drained. Also, the light traction exerted on the tissues permits the opening of the lymphatic walls and facilitates the mobilization of the lymph.

Electrically driven vibrators and massagers are well known in the art. However, those that are hand held generally require the motor portion thereof to be held immobile while a single driven applicator portion moves through a prescribed motion which, typically, is linear, rotational, vibratory or some combination thereof. The applicator is then applied to a body part to impart such motion thereto. However, various conditions, for example, arthritis and certain joint and cellulite related conditions are more amenable to massage therapy if a stretching motion of the applicator is available.

In the prior art, various types of equipment have been proposed to facilitate such massage. Generally, such equipment exerts, on the selected portion of the human body, an action of pressure, tissue displacement, friction, undulation, or some combination thereof. However, little in the prior art addresses the induction of combined stresses in what is known as the art of endermology as a “rolling palpation” which has particular application in the treatment of coetaneous, cellulitis and other dermatologic conditions. The role of the palpation technique involves furnishing to a subject a combination of a pinching action and continuous rolling action across a fixed tissue specific displacement of the pinched area to generate a roll in the skin while at the same time exerting pressure upon opposite sides thereof. Therein, the direction of rotation of the applications must conform to the linear direction of rotation of the outline device. Such an objective of the prior art is reflected in U.S. Pat. No. 4,729,368 (1988) to Guitay, entitled Apparatus for Massaging the Human Body and U.S. Pat. No. 5,665,053 (1997) to Jacobs, entitled Apparatus for Performing Endermology. However, such references teach devices which, while functional in theory, do not provide a durable, stable and reliable mechanical system capable of operating without malfunctioning over an extended period of time. Because Guitay is reliant upon the use of springs, it is inherently less stable than a far simpler device and cannot provide defined, constant and reliable tissue displacement during operation thereof. Jacobs is dependent on the use of ultrasound, thereby rendering it subject to regulation as a medical device.

The prior art, inclusive of the present invention, employs suction against the human skin to optimize massage techniques applicable in the treatment of cellulite and related skin disorders. Understandably, the coordination and integration of the effects of the suction with the balancing of spring constants has made for a formidable engineering problem and, as above noted, one which has resulted in problems of maintenance and durability. The present invention seeks to simplify and improve the mechanics of a variable displacement and rotating massage device so that, over extended periods, the internal suction may be used without degrading the durability and accuracy thereof. Another issue is ease of use and expense. The prior art has not been readily available at reasonable fees to the general public. What good is the prior art to the average consumer without the means to access it? The cost alone is a deterring factor to many people. The necessity of appointments, scheduling conflicts and time constraints also make the prior art inaccessible to many in the general public. The present invention seeks to make affordable and accessible the means to improve the appearance of cellulite with ease of use, in the privacy of one's own home.

### SUMMARY OF THE INVENTION

The object of the present invention is to overcome, at least in part, the above-mentioned shortcomings, in a manner to permit the roller means and suction means to be united in the same apparatus in a simplified, yet highly effective manner, made with durability and maintenance-free materials. The most advantageous aspect of the current invention, compared to all others before, is the intention of its home use; that is to say the massage apparatus is designed and intended to be attached to any standard vacuum hose that is attached to and powered by any standard, 12 amp household vacuum. The user simply does so, turns the vacuum on and applies the massage apparatus, the Massage apparatus, against the areas of the skin desired to be treated, in a back and forth motion, rolling, pushing and pulling it, as the suction source, any standard, 12 amp household vacuum, draws the skin up into the chamber, in a palpate-roll manner. The user would perform these actions to the areas of the skin to be treated to improve the appearance of said user's cellulite. The suction from the standard, 12 amp household vacuum serves to form a fold of skin pressing, palpating and rolling the affected areas. The “palpate-roll” type of massage has a defibrating effect: the pressure followed by the pulling applied to the skin tissue has its effect to stimulate the elastin fibers and improve circulation. The two effects, associated with decongestion of the tissues, allow the skin to return to its good tone. The defibrating improves the trophicity of the tissues and acts on their restructuring. Progressive placing under tension of the tissues at the level of the rolled skin fold accelerates the phenomenon of tissue softening. The releasing of the fibers of the vertical walls limits the stresses responsible for the “orange peel” appearance of cellulite. Moreover, hypervascularization provokes a blood mobilization in the capillaries improving the trophicity and the cellular nutrition in depth and at a distance. The suction drainage improves the trophicity and simultaneously softens the tissues leading to a better sliding of the skin tissue layers. It permits liquids (interstitial liquids, water, blood, lymph) to better transport the nutrient supply and to better evacuate toxins. The tissue spaces are better drained. Finally, the light traction exerted on the tissues permits the opening of the lymphatic walls and facilitates the mobilization of the lymph.

The skin and muscle stimulating apparatus, the Massage apparatus, consists of a treatment head connected to a standard vacuum hose that is connected and powered by a standard, 12 amp household vacuum, said treatment head comprising a box that can be operated manually with ease, said box comprising an internal chamber open at the base thereof, which chamber is sealed when the apparatus is applied to the user to be treated, said chamber being defined by four fixed side walls and two transverse surfaces arranged facing one another between said side walls, both of the transverse surfaces comprising a periphery of a roller driven positively in rotation, the standard, 12 amp household vacuum opening into said chamber and serving to create suction when the apparatus is applied against the body of the user, by the user, which suction serves to exert, on the selected portion of the human body, an action of pressure, tissue displacement, friction, undulation, and any combination thereof to improve the unsightly appearance of cellulite on the treated areas.

It is accordingly an object of the invention to provide an improved, yet simplified, device having improved efficiency when used in the treatment of cellulitis, cutaneous and other dermatologic zones of the human body.

It is another object of the invention to provide an improved, yet simplified apparatus for performing self massage for physical therapy for home use.

It is a further object of the invention to provide a device of the above type which is not reliant upon the use of springs or biasing means for the operability thereof.

It is still a further object to provide a massage device which is durable during long term use within a negative pressure environment.

It is still a further object of the invention to provide a means of the above type available for home use to any consumer, thereby providing convenience, accessibility, and privacy to the user.

It is still a further object of the invention to provide a device of the above type to the general public for home use at an affordable price thereby making this type of massage therapy available to all, and thereby eliminating the need for expensive treatments provided by practitioners, and further eliminating the need and inconvenience of office appointments to provide aforementioned treatments.

### BRIEF DESCRIPTION OF THE DRAWINGS

FIG. 1 is an isometric view of housing, of the Massage apparatus in accordance of the present invention;

FIG. 2 is a bottom view of the Massage apparatus showing two rollers mounts to the housing;

FIG. 3 is an isometric view of the two rollers that attach to FIG. 2 bottom view roller mounts;

FIG. 4 is a transparent front view that shows the mounts for the two rollers;

FIG. 5 is a cross section side view, showing roller placement attached to housing;

### DETAILED DESCRIPTION OF THE INVENTION

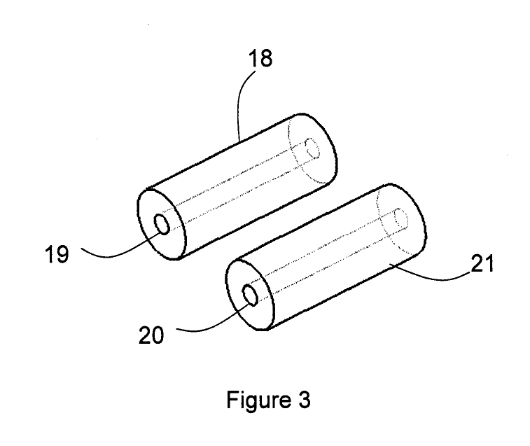

Referring to FIG. 1, the Massage apparatus, a massager in accordance with the preferred embodiment of the present invention. Massager comprises a housing FIG. 1 formed generally as two portions, a base portion 10, handle portion 11 and roller portion FIG. 3. The handle portion 12 of FIG. 1 includes one handle that is also the end attachment for suction opening whereby the standard vacuum hose on any standard, 12 amp household vacuum attaches, making it ready for use by the user.

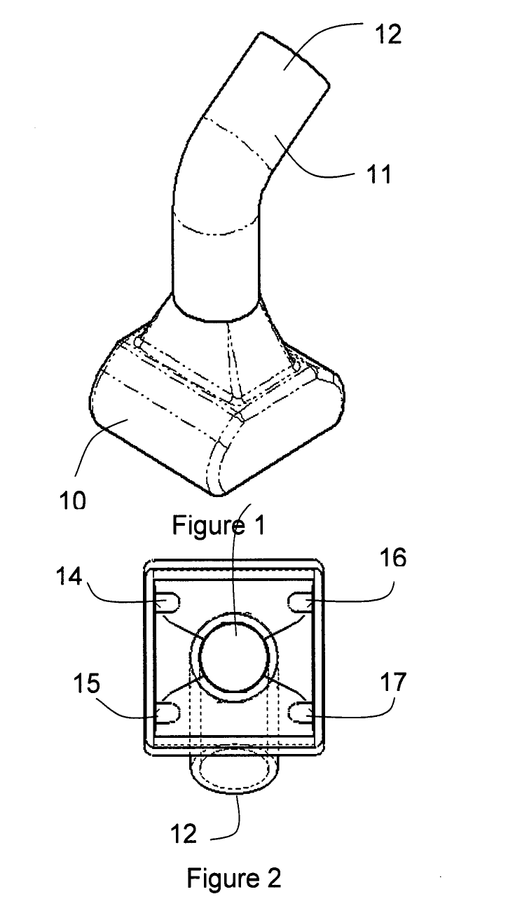

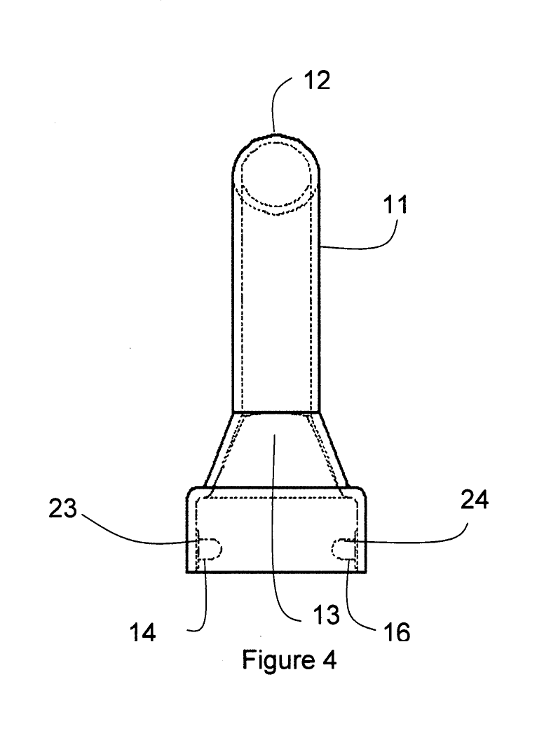

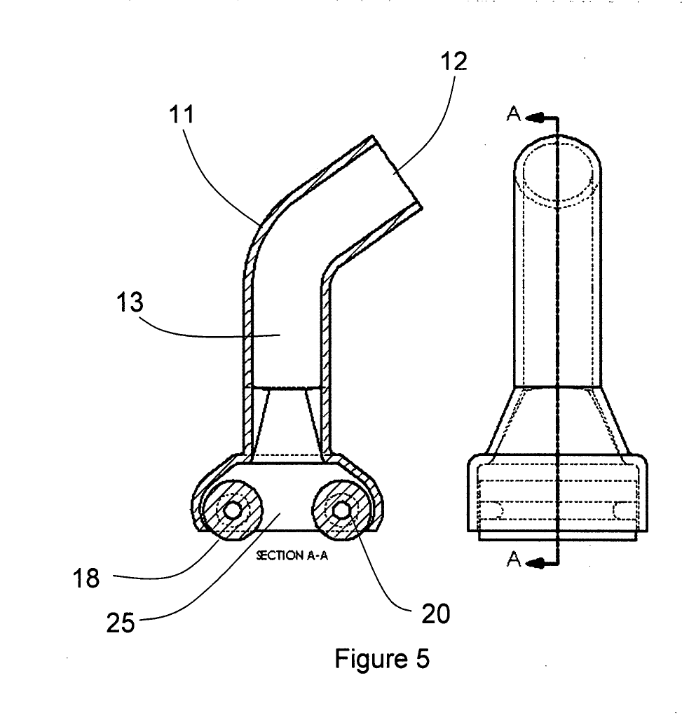

Parallel rollers FIG. 3 attach individually to base housing mounts 14, 15, 16, and 17 in connection with roller mounting holes 19, 20 of FIG. 3. Surface of rollers 18, 21 are specifically gapped 0.75 of an inch 25, which allows skin surface and muscle tissue to be pulled between rollers and up base shaft 13. Each roller is spaced 0.0325 inch, from base housing 23, 24. Base mounts for rollers 14, 15, 16, and 17 of FIG. 2 are specifically located on base housing 10, which allows roller surfaces 18 and 21 of FIG. 3 to protrude 0.125 inch below base housing. This is unique for air suction to pull skin and muscle tissues up base shaft 13 of FIG. 4.

While holding the handle 11 of base unit FIG. 1, applied pressure to skin surface allows rollers FIG. 3, to roll uniform in same direction, with suction action from standard 12 Amp vacuum cleaner pulls skin surface and muscle tissue between rollers FIG. 3 up housing shaft 13 of FIG. 4.

While there has been shown and described the preferred embodiment of the present invention, it is to be appreciated that the invention may be embodied otherwise than is herein specifically shown and described and that, within said embodiment, certain changes may be made in the form and arrangement of parts without departing from the underlying ideas or principles of this invention, the Massage apparatus, as set forth in the Claims appended herewith.

Having thus described our invention, what we claim as new, useful and non-obvious and, accordingly, secure by Letters of Patent of the United States is:

1. A massage apparatus comprising a hollow handle portion communicating at one end with a head portion having an open end attachable to as suction means, said head portion comprising an internal air chamber having an opening at the bottom thereof for communication with the human body, a pair of spaced apart parallel rollers rotatably mounted over the vertical edges of said opening and protruding below said opening so that when the rollers are applied to the human body and the handle is attached to a suction means, the skin tissue of said human body is drawn up between said rollers.

2. The apparatus of claim No. 1 wherein the handle is attached to a suction means.

3. The apparatus of claim No. 1 wherein the suction means is a household vacuum.

4. The apparatus of claim No. 3 wherein the household vacuum is a standard 12 amp vacuum.

5. A method of conditioning tissue in a treatment area after a liposuction procedure comprising the steps of:
(a) providing a massage apparatus;
(b) identifying the tissue to be conditioned which defines a treatment area; and
(c) applying the massage apparatus to the treatment area to smooth the tissue after a liposuction procedure.

6. The method of claim 3, wherein the tissue is skin.

7. The method of claim 3, wherein the tissue is fat.
